(19) United States
(12) Patent Application Publication
(10) Pub. No.: US 2017/0341541 A1
(43) Pub. Date: Nov. 30, 2017

(54) SEAT FOR INFANTS AND TODDLERS WITH A DAMPING DEVICE

(71) Applicant: CURT WUERSTL VERMOEGENSVERWALTUNGS-GMBH & CO. KG, Hof (DE)

(72) Inventor: Jan-Stefan Wuerstl, Regnitzlosau (DE)

(21) Appl. No.: 15/537,827

(22) PCT Filed: Dec. 18, 2015
(86) PCT No.: PCT/EP2015/002553

§ 371 Date: Jun. 19, 2017

(30) Foreign Application Priority Data
Dec. 19, 2014 (DE) 20 2014 106 183.5
Apr. 30, 2015 (DE) 10 2015 106 803.6

(51) Int. Cl. B60N 2/28

(52) U.S. Cl. CPC B60N 2/2884; B60N 2/2878; B60N 2/2845; B60N 2/2863

(57) ABSTRACT

Provided is a seat for infants and toddlers, which has at least one seat lower part and a seat back part, wherein a seat element and a backrest element are applied on the seat lower part and on the seat back part respectively, in a moveable manner and connected to one another. At least the backrest element is flexibly designed and is arranged at a distance from the seat back part, wherein the backrest element can be moved in the event of an influence of an impulse energy by the body of a child. At least one damping device allows a movement of the backrest element from a determined impulse energy, by which means the distance between the backrest element and the seat back part is reduced and a movement of the seat element occurs with respect to the seat lower part.

The present invention relates to a seat for infants and toddlers, with a damping device, comprising at least a seat lower part and a seat back part, wherein a seat element at the seat lower part and a backrest element at the seat back part are mounted to be displaceably connected together.

Seats of that kind for children and babies are used particularly in motor vehicles, in which case these seats are connected with a vehicle seat by way of a vehicle belt system or with the vehicle seat by way of a so-called ISOFIX connection. In addition, seats of that kind can also be attached to support systems which are in turn connected with the vehicle seat and/or the vehicle floor (for example ISOFIX system, support foot).

In the case of such child seats distinction is usually made between bucket seats for infants and toddlers and child seats for older children. Bucket seats for infants and toddlers are constructed as rear-facing seats, in which the viewing direction of a child received therein is oriented towards the back of the vehicle. In the case of child seats for older children the viewing direction of a child received therein is oriented towards the front of the vehicle. Proposals have been made for both kinds of child seats with regard to how the forces arising in the event of an accident and acting on a small child can be reduced and absorbed by the child seats. In addition, child seats are known from the prior art in which a backrest element is displaceable with respect to a seat element so as to, for example, bring a child received in a bucket seat from a seating position to a lying position. Such a child seat is described in, for example, DE 20 2011 000 229 U1.

DE 10 2011 003 650 A1 discloses an energy-absorbing deformation structure for protection of the human body, wherein a child seat can have a deformation element which is constructed from foamed material and which is compressed when loaded and expands again when loaded.

In addition, DE 10 2011 013 373 A1 discloses a baby support system with a shell having a receptacle for reception of a baby, wherein mounting points at which the shell can be mounted for rotation at a horizontally oriented pivot axis extending through the mounting points are present at the shell. In the event of an accident the shell can be pivoted in the direction of travel and oppositely to the direction of travel.

DE 72 16 625 U discloses a removable car child seat consisting of a subframe, a seat surface, a backrest and two side walls attached to the subframe, in which the seat is adjustable from a seating setting to a lying setting and a locking device is provided which locks the seat in the seating setting and releases it if a specific negative vehicle acceleration is exceeded.

However, the child seats known from the prior art do not represent a satisfactory solution with regard to energy absorption in the case of an accident, since the body of the child is merely pressed against a damping element or the child is pivoted.

The object of the present invention is therefore to indicate a seat for infants and toddlers which represents an alternative solution to the child seats known from the prior art and in which the impulse energy occurring in the event of an accident is absorbed by the seat.

The object is fulfilled by a seat with the technical features indicated in claim 1. Advantageous developments of the invention are indicated in detail in the subclaims.

In a seat according to the invention for infants and toddlers, comprising at least a seat lower part and a seat back part, wherein a seat element at the seat lower part and a backrest element at the seat back part are mounted to be displaceable and connected together,
at least the backrest element is of flexible construction and arranged at a spacing from the seat back part,
the backrest element is so arranged and constructed that the backrest element is displaceable under the action of impulse energy by the child,
at least one of the backrest element and the seat element is connected with at least one damping device and
the at least one damping device allows displacement of the backrest element from a definable level of impulse energy, whereby the spacing between the backrest element and the seat back part is reduced and displacement of the seat element relative to the seat lower part takes place.

By contrast to the child seats known from the prior art the backrest element of is flexible construction and therefore enables, solely by deformation thereof, absorption of a specific amount of the energy occurring in the event of an accident. Advantageously, in that regard there is to be understood by “deformation” an irreversible plastic deformation, a reversible elastic deformation and/or also a partly-plastic deformation and/or a combination thereof.

In fact, child seats known from the prior art have cushioning which rests on the backrest element similarly to the seat according to the invention for infants and toddlers, but cushions of that kind are not in a position of absorbing even at least partly or to a measurable extent the energy in the case of an accident.

In addition, in the seat according to the invention the backrest element is so arranged that in the event of an accident this is displaced, in which case the displacement of the backrest element takes up and absorbs at least a part of the energy occurring in the event of an accident. Movement and deformation of the backrest element thus absorb at least partly the energy liberated when an accident occurs. In addition, the seat element is displaced relative to the seat lower part through the coupling with the backrest element. The displacement of the seat element similarly produces at least partial absorption of the energy occurring in the event of accident. However, the displacement of the seat element and/or the displacement of the backrest element happens or happen only when a minimum force or minimum impulse energy acts on the child and/or the seat. Small forces acting on the child or the seat due to, for example, braking therefore do not have the consequence of the backrest element and/or the seat element being displaced. However, braking forces can already cause the backrest element to be at least partly deformed. Advantageously, displacement takes place only when, for example, a significantly greater force due to liberated energy acts on the child and/or the seat in the case of an accident. The damping device and/or the backrest element absorbs or absorb the energy liberated in the case of an accident or severe braking. If the liberated energy is smaller than or equal to the absorption capability of the damping device and/or the backrest element then displacement of the backrest element and the seat element does not take place, but advantageously merely deformation. Depending on the magnitude of the impulse energy acting on the child, deformation of the backrest element is already possible without displacement taking place or being necessary. If, however, the liberated energy is greater than the absorption capability of the damping device then the damping device allows displacement. In that regard, the damping device can comprise mechanical components which are coupled or connected with the seat element and/or the backrest element, in which case displacement of the backrest element and the seat element can be performed only by way of the mechanical components. If the mechanical components are not freed, for example because the energy liberated by braking is too small for that purpose, no displacement takes place. If the liberated energy is significantly greater, the mechanical components are freed and displacement of the backrest element and the seat element takes place. However, in further embodiments at least the backrest element is of flexible construction in such a way that this can absorb a defined amount of the liberated energy by deformation. In that regard, for example, in the case of a small amount of liberated energy—namely an amount insufficient for displacement of the backrest element and the seat element—the small amount of liberated energy can be absorbed by way of the backrest element, which for that purpose is deformed to a specific extent. In the case of a higher amounts of liberated energy a part of the energy is absorbed by the damping device, a part of the energy is absorbed by displacement of the backrest element and the seat element and a part of the energy is absorbed by way of the backrest element.

In addition, it is also conceivable in the case of the seat described here for the backrest element to be so arranged and constructed that the backrest element is deformable and/or displaceable in the case of action of impulse energy by the body of a child. Depending on the energy action on the body of a child, which is thereby pressed against the backrest element and/or the seat element, advantageously deformation of the backrest element and/or seat element takes place and the energy which acts is absorbed. If the energy absorption capacity of the backrest element and/or seat element is exceeded the backrest element and/or seat element is or are displaced in position.

This is obviously not to be understood as limiting, so that it is also conceivable for the energy absorption capacity of the backrest element and/or seat element to be designed in such a way that deformation without displacement is sufficient and offers adequate safety. Moreover, it is also conceivable that in the event of an accident initially the backrest element and/or seat element is or are displaced in order to thereafter absorb, by deformation, the residual impulse energy which acts.

In addition, in the case of the seat according to the invention there is not mere pivotation or pressing of a child into a foam material cushion, but rather absorption of the liberated energy takes place by deformation of the backrest element and/or shifting thereof (for example pressing down by at least 2 centimetres) and/or displacement of the seat element. In the case of the seat according to the invention not only pivotation of a child about a defined position thus takes place if the liberated energy exceeds a specific amount, but equally displacement and/or deformation occurs or occur. As a consequence thereof a combination of displacement and/or pivotation and/or deformation takes place.

Moreover, the seat described here is advantageous because, due to the deformation and/or displacement and/or pivotation of the backrest element and/or seat element in the event of an impact, the child present in the seat is brought from an initially lying position to a more upright position, for example a half-seating position. The spinal column of the child is thus additionally protected from damaging overload in the event of an impact.

The backrest element can be arranged, in a lying position, at a spacing from the seat back part. For that purpose, for example, the backrest element can have, in a further seating position, a smaller spacing from the seat back part. The backrest element can be brought by way of a mechanism from a seating position, in which the backrest element has a smaller spacing from the seat back part, to the lying position.

The seat lower part and the seat back part can be components of a bucket seat of a baby carrier to which a carry yoke is pivotably attached at least at one end and the backrest can be coupled with the carry yoke of the seat, wherein the backrest element can be brought from the seating position to the lying position by way of displacement of the carry yoke from a first position to a second position. The backrest element can be brought from the seating position to a lying position directly by the carry yoke or by way of the seat element and the coupling thereof with the carry yoke. A mechanism for bringing a backrest element from a seating position to a lying position and conversely by means of a carry yoke is described in, for example, DE 20 2011 000 229 U1.

The seat element and the backrest element can be so constructed in the connection region thereof that in the case of bringing from a lying position to a seating position and conversely the support area, which is provided by the backrest element and the seat element, for a child is decreased or increased.

The seat element can be coupled with at least one displacing element and connected with the carry yoke and the connection of the seat element with the backrest element causes the backrest element to be brought from the seating position to the lying position. The displacing element produces the movement for bringing from the lying position to the seating position and conversely and can additionally limit, by way of a guide, the extent of pivotation of the seat element with respect to the backrest element. The displacing element can also be connected with the damping device. In that case, the backrest element and the seat element are indirectly connected with the damping device. In the case of transfer from the seating position to the lying position the angle of the seat element with respect to the backrest element is increased so that a child received thereon can be held in a lying position.

For that purpose the angle between the backrest element and the seat element can be variable. In particular, variation in the angle between the backrest element and the seat element occurs when the seat or seat element and the backrest element are brought from a seating position to a lying position.

An upper end of the backrest element can be connected with the seat back part.

In addition, the upper end of the backrest element can be connected with the seat back part to be pivotable and/or displaceable. In the case of a pivotable connection of the backrest element, in the event of an accident there is not a uniform change of the spacing of the backrest element from the seat back part, but a non-uniform reduction in the spacing, wherein the backrest element is moved in a lower region significantly further in the direction of the seat back part than the sections extending thereabove. In particular, the backrest element in the connecting region with the seat back part cannot be pivoted, but may only allow deformation due to the flexible form thereof.

A connecting region between the seat element and the backrest element can be constructed to be reinforced. This connecting region in the event of an accident thereby absorbs less energy, but produces a displacement of the seat lower part as a consequence of the force which arises in the event of an accident and the corresponding pressure exerted by way of the child on the connecting region.

The seat element can be coupled with at least one transmission element which guides the displacement of the seat element relative to the seat lower part.

The backrest element can be coupled with at least one transmission element which guides the pressing down and displacement of the backrest element relative to the seat back part. The transmission element for the seat element and the transmission element for the backrest element can, in further embodiments, also be provided in combination and can guide the movement of the backrest element and the seat element.

The carry yoke can be pivotably mounted substantially on the centre-of-gravity axis of the seat and be lockable at least in the vertical carry setting. For preference, the carry yoke is lockable not only in the vertical carrying setting, but also in a substantially horizontal setting. In further embodiments of a seat with a backrest element and a seat element able to be brought from a lying position to a seating position and conversely, the carry yoke in the vertical carrying setting defines the seating position and in the substantially horizontal setting defines the lying position.

The backrest element and/or the seat element can consist of plastics material with a resilient property. In particular, the backrest element and/or the seat element can consist of a resiliently deformable plastics material and/or comprise a resiliently deformable plastics material, such as, for example, a plastics material foam. This is obviously to be understood as non-limiting, so that it is also possible for the backrest element and/or the seat element to be constructed from an at least partly plastically deformable plastics material. In this case, backrest element and/or seat element is or are irreversibly deformed in the event of an accident, whereas the effective impulse force from backrest element and/or seat element is at least partly absorbed.

The backrest element can have openings through which the belts of a restraining system are guided, in which case the belts are connected with the seat back part.

In further embodiments the backrest element has a structure which assists introduction of force by the body of a child into the lower region of the backrest element. For that purpose, for example, the lower region of the backrest element can be of more flexible construction than the upper region of the backrest element.

The backrest element can consist of interconnected plastics material strips which have a longer dimension in length direction than in transverse direction and the arrangement of which forms a resilient base.

In addition, the plastics material strips can be arranged at a spacing from one another so that openings are provided between the plastics material strips.

The at least one damping device can be coupled with the backrest element and the seat element in the region of a connection axis of the backrest element and the seat element.

The at least one damping device can comprise hydraulic, magnetic and/or mechanical braking means. The at least one damping device can be so arranged at the seat that it acts oppositely to the movement direction of the backrest element and/or the seat element so that the damping device prevents movement (displacement) of the backrest element and the seat element. The damping device allows movement of the backrest element and the seat element only when the liberated energy (for example due to an accident) is greater than the resistance or absorption capability of the damping device. Hydraulic damping devices comprise, for example, a piston which is displaced in a fluid-filled (for example, oil-filled) chamber or a rotor part which can be rotated in a fluid-filled chamber. Due to the viscosity (for example, of oil), the movement of the piston or the rotor part is inhibited. Thus, shifting (displacement) of the backrest element and of the seat element, for example, can also take place in variable manner, in which case the displacement of the backrest element and the seat element increases, i.e. if the liberated energy exceeds the absorption capability of the damping device only slightly a small and slow displacement takes place, but if the liberated energy significantly exceeds the absorption capability of the damping device then a rapid displacement to a greater extent takes place. The at least one damping device can also be constructed as a so-called absorption buffer.

Magnetic braking means can be so arranged, for example, that in a normal setting of the backrest element and of the seat element unlike poles are opposite. In order to separate the unlike poles from one another and/or to move like poles towards one another, a specific minimum force or a specific moment is required. The force needed for that purpose or moment needed for that purpose results from the liberated energy, for example due to an accident. Thus, displacement takes place only when a specific level or energy acts on the seat or the child. The amount of energy required for displacement can be set by way of the construction and selection of the magnets.

For example, the spacing of the magnets from one another can be changed in order to vary the energy required for an adjustment. In addition, the magnets can be exchanged for that purpose. In the case of hydraulic braking means, for example, the maximum possible stroke of a piston could be varied so as to set an adaptation to the required minimum energy.

In further embodiments the at least one damping device comprises two friction surfaces displaceable or rotatable relative to one another, wherein one friction surface is connected or coupled with the seat (for example a side wall) and the other friction surface with the backrest element and/or the seat element. In order to effect displacement of the backrest element, the friction surfaces have to be shifted relative to one another. A defined minimum amount of energy is required for that purpose. If the spacing of the friction surface or if, by way of further means, the pressure of the two friction surfaces against one another is varied then a displacement of the friction surfaces relative to one another can take place more easily (greater spacing/lesser pressure) or in a more heavy-going manner (smaller spacing/larger pressure). For that purpose, the friction surfaces can, for example, be coupled with an adjusting device. In a simple embodiment the adjusting device comprises an adjusting wheel, rotation of which produces a change in spacing of the friction surfaces relative to one another. For that purpose, at least one of the friction surfaces can also be pressed against the other friction surface by way of a spring device. The friction surface with the spring device has a thread disposed in engagement with a threaded section on a shaft, the shaft being connected with the adjusting wheel. If the adjusting wheel is turned, the friction surface is moved relative to the other friction surface, in which case the friction surfaces are guided so that the movement is predetermined. In addition, a spring device can be provided to serve the purpose of moving the friction surfaces towards one another. Adjusting devices of that kind can, however, also have only a threaded arrangement or a spring arrangement, in which case the friction surfaces can be moved towards one another by way of the threaded arrangement and the spring arrangement. In that regard, for example, an exchange of the springs or change in the friction between the friction surfaces is possible. Moreover, the friction surfaces can be exchanged or additional elements (for example friction surfaces) can be used for changing the spacing or pressure.

Depending on the construction and arrangement of the backrest element and the seat element, in the case of exceeding of a defined impulse energy when displacement of the backrest element and of the seat elements takes place a pivotation of the backrest element and/or of the seat element occurs so that the angle between the backrest element and the seat element is decreased or increased.

The at least one damping device can comprise at least one spring which opposes displacement of the backrest element and the seat element, wherein the at least one spring is coupled or connected with the backrest element, the seat element and/or the displacing element. The spring can be, for example, a tension spring, which is coupled at one end to an immovable part of the seat and/or at another end to the backrest element, the seat element and/or the displacing element. If the spring is exchanged or the number of springs changed, adaptation of the required minimum amount of energy for displacement can be undertaken. This is necessary particularly when children with a different weight are to be transported or when a child grows and thus the weight of the child increases.

The at least one damping device can comprise a multi-disc brake which is coupled to or connected with the backrest element, the seat element and/or the displacing element. As multi-disc brake for the damping device, for example, a rotor (shaft) having components mounted in an oil bath is used for the seat. However, use can also be made of magnetic multi-disc brakes, in which case arranged at the rotor are magnets which in a normal setting lie opposite unlike poles of magnets of a stator. In order to be able to rotate the rotor, the magnets have to be brought relative to one another in such a way that the like poles of the rotor magnets and the stator magnets are opposite, for which purpose a defined requisite minimum amount of energy has to be expended.

Moreover it is conceivable to construct the damping device at least partly on and/or under and/or in the backrest element and/or as a component of the backrest element. This is of advantage particularly if the damping device is constructed from reversibly and/or at least partly irreversibly deformable foamed plastics material. This assists the flexibility and deformation of the backrest element so that higher effective impulse forces can be absorbed and safety is increased.

The seat can be so arranged on a vehicle seat opposite to the travel direction of the vehicle that the viewing direction of a child received therein is oriented towards the vehicle rear side. In these embodiments, the seat can be constructed as a bucket seat and, in particular, as a so-called rear-facing seat.

Alternatively thereto, the seat can be so arranged on a vehicle in the direction of travel thereof that the viewing direction of a child received therein is oriented towards the vehicle front side. Such a seat can be constructed not only as a bucket seat for infants and toddlers, but also as a conventional child seat for older children.

The present invention is restricted neither to bucket seats for infants and toddlers nor to child seats for older children.

The flexible design of the backrest element combined with the displacement of the seat element produces, in a multiplicity of applications and design possibilities of child seats, a significantly improved capability of energy absorption in the event of an accident.

Further advantages, features and design possibilities are evident from the following figure description of embodiments, which are not to be understood as restrictive.

In the drawings:

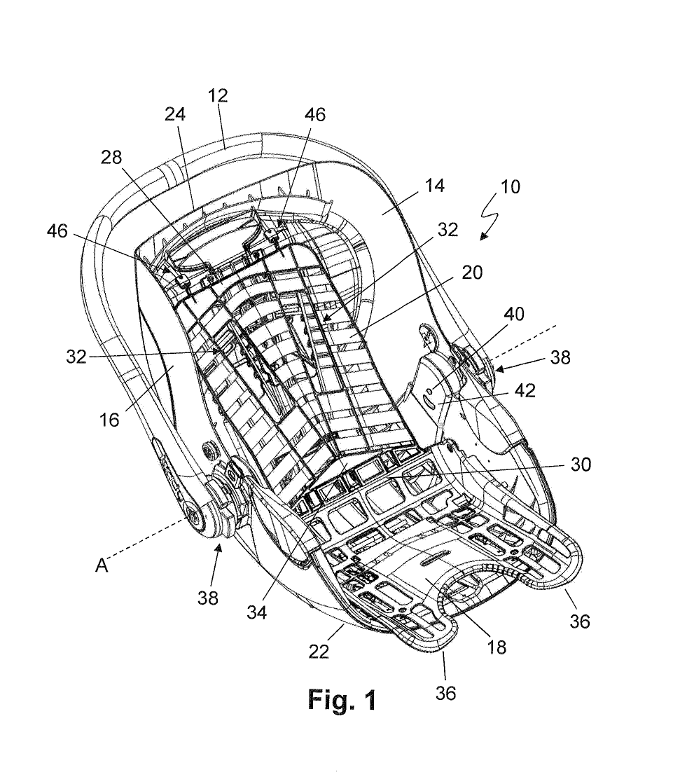

FIG. 1 shows a schematic illustration of a seat in perspective view;

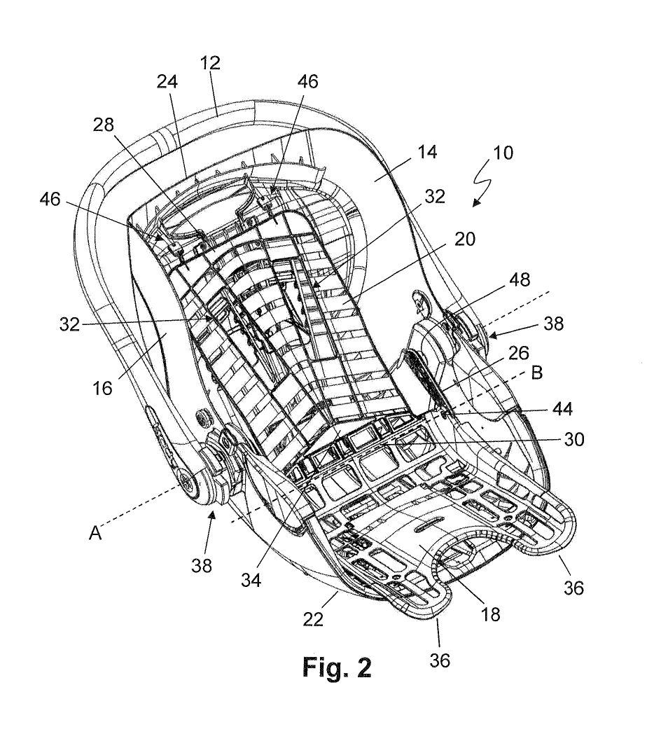

FIG. 2 shows a schematic illustration of a seat with displacing elements in perspective view;

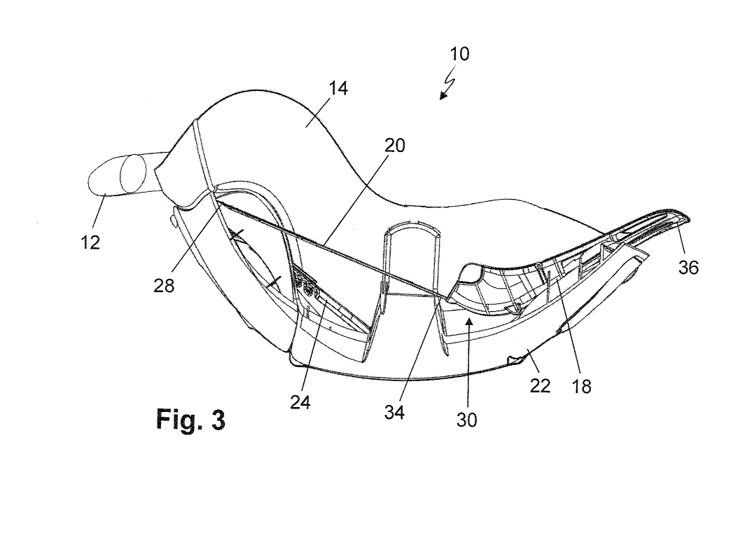

FIG. 3 shows a section through the seat of FIG. 1;

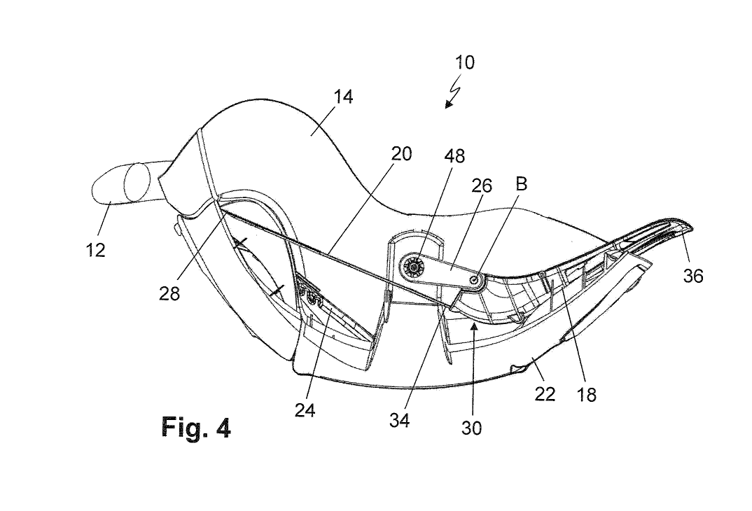

FIG. 4 shows a section through the seat of FIG. 2;

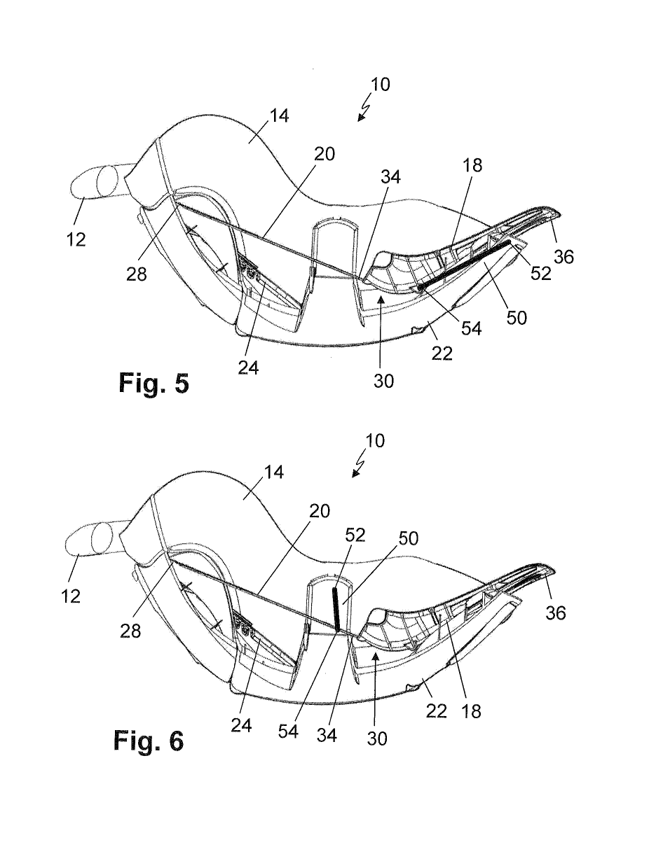

FIG. 5 shows a schematic illustration of a seat with a damping element, which is constructed as a tension spring, of a damping device; and

FIG. 6 shows a further schematic illustration of a seat with a damping element, which is constructed as a tension spring, of a damping device.

Parts and components provided in the figures with the same reference numerals substantially correspond with one another insofar as nothing to the contrary is indicated. In addition, description of components which are not of significance for understanding of the technical teaching disclosed herein is dispensed with.

FIGS. 1 to 6 show an embodiment for bucket seats, wherein the technical teaching described herein is not restricted thereto, but can also be used for child seats not constructed as bucket seats for infants and toddlers.

FIG. 1 shows a child seat 10 without a cushion and a belt system, which serves for fixing an infant or toddler in the seat 10. In addition, the illustration of FIG. 1 does not show a connection of the seat 10 with a vehicle seat. A connection with a vehicle seat of a vehicle by way of a vehicle belt system or an ISOFIX coupling can be provided for the seat 10.

The seat 10 comprises two opposite side walls 14 and 16, a seat lower part 22 arranged between the side walls 14 and 16 and connected with the side walls 14 and 16, and a seat back part 24 arranged between the side walls 14 and 16 and connected with the side walls 14 and 16. The side walls 14 and 16, the seat lower part 22 and the seat back part 24 form a shell of the seat 10. A backrest element 20 is arranged at the seat back part 24. The backrest element 20 is connected at the upper end 28 thereof with the seat back part 24 by way of two suspension devices 46. The backrest element 20 is connected with the seat element 18 at the lower region 34 of the backrest element 20. The seat element 18 rests on the seat lower part 22. The seat element 18 has two protruding leg support regions 36. The support regions 36 serve the purpose of supporting the legs of a child. A connecting region 30 between the seat element 18 and the backrest element 20 is so constructed that when the backrest element 20 and the seat element 18 are brought, the support area, which is provided by the backrest element 20 and the seat element 18, for a child is increased or decreased. FIG. 1 shows the lying position, wherein the support region is increased by way of the backrest element 20 and the seat element 18. Moreover, the connecting region 30 is constructed to be reinforced so that this substantially cannot be deformed. By contrast, the backrest element 20 is made from a flexible material or constructed to be flexible so that the backrest element 20 can be moved in the direction of the seat back element 24 and in addition is deformable. For that purpose, the backrest element 20 is arranged at a spacing from the seat back part 24. The spacing between the seat back part 24 and the backrest element 20 in the lower region 34 of the backrest element 20 is at least 2 centimetres.

The seat 10 additionally comprises a carry yoke 12. The carry yoke 12 is substantially mounted at the centre-of-gravity axis A of the seat 10 and is pivotable about the centre-of-gravity axis A. In FIG. 1 the carry yoke 12 is disposed in the rear position (substantially horizontal setting) and is locked in this position by way of locking devices 38. The carry yoke 12 can be pivoted forwardly so that this is in a substantially vertical carrying setting. The carry yoke 12 can similarly be locked in this vertical carrying setting by way of the locking devices 38. The carry yoke 12 is coupled with displacing elements 26, which are not illustrated in FIG. 1 (see FIG. 2).

The displacing elements 26 are rotatably mounted by way of a shaft in openings 40 and have guide means guided in guide gates 42. In addition the displacing elements 26 are connected with the seat element 18. The displacing elements 26 can be pivoted about the centre-of-gravity axis A, the displacing elements 26 being connected with a multi-disc brake 48. The extent of pivotation of the displacing elements 26 is limited by way of the guide projections in the guide gates 42. The displacing elements 26 serve the purpose of bringing the seating element 18 and the backrest element 20 from the lying position, which is shown in FIG. 1, into a seating position, in which case for that purpose the seat element 18 is pushed into the seat 10 and the backrest element 20 is thereby pivoted about a notional line in the upper end 28 of the backrest element 20, the spacing of the backrest element 20 from the seat back part 24 in the back region 34 being reduced. The multi-disc brakes 48 are arranged in the cover, which is illustrated in FIGS. 1 and 2, between the locking device 38 and the displacing element 26. Merely the shaft (rotor), which is connected with the multi-disc brake 48 and connected with the displacing element 26, is illustrated here. A part (stator) of the multi-disc brake 48 is fixedly connected with the seat 10, in which case the rotor (shaft) can be rotated only when there is action on the shaft of a specific required minimum torque which in the event of an accident is produced by way of the force acting through the child on the transmission elements 26. This force generates a moment on the transmission elements 26, which then seek to rotate about the centre-of-gravity axis A. The multi-disc brake 48 comprises, for example, stator magnets opposite the rotor magnets of the shaft. In a neutral setting, the unlike poles of the magnets of the stator and of the rotor are opposite. However, in order that the shaft can be rotated a minimum moment has to act on the shaft in order to turn the shaft, in which case like magnets of the rotor and the stator are opposite.

The multi-disc brakes 48 serve the purpose of allowing the displacement or a pivotation of the displacing elements 26 and thus pivotation of the seat element 18 and the backrest 20 only when a requisite minimum amount of energy acts on the seat 10 or a child received therein. The multi-disc brakes 48 brake the movement of the displacing elements 26 and at least partly absorb the energy occurring in the event of an accident. If the energy liberated in the event of an accident is small then this energy is not sufficient for the purpose of moving the child, who is received in the seat 10, by way of the seat element 18 and the backrest element 20 in the direction of the seat back part 24. If the energy liberated in the event of an accident exceeds the absorption capability of the multi-disc brakes 48 or if the multi-disc brakes 48 can absorb the liberated energy only in part a pivotation of the displacing elements 26, which ultimately leads to displacement of the seat element 18 and the backrest element 20, takes place. The displacing of the seat element 18 and the backrest element 20 in that case absorbs a part of the energy liberated in the event of an accident. The flexible backrest element 20 additionally absorbs a part of the energy liberated in the event of an accident or acting on the child, as a result of which high loads are not imposed on the child received in the seat 10.

The backrest element 20 consists of interconnected plastics material strips. The plastics material strips consist of a plastics material with a resilient characteristic. In addition, the connecting webs which connect the plastics material strips together consist of a plastics material with a resilient characteristic. The plastics material strips are arranged at a spacing from one another so that the thereby-formed structure forms a resilient base by virtue of the materials used and the arrangement thereof. The seat element 18 consists of a plastics material without a resilient characteristic and is of substantially inflexible construction. In addition, the side walls 14 and 16, the seat lower part 22, the seat back part 24 and the carry yoke 12 are made from a non-resilient plastics material.

FIG. 2 shows a schematic illustration of a seat 10 with displacing elements 26, which are connected with the multi-disc brakes 48, in perspective view. The seat 10 illustrated in FIG. 2 substantially corresponds with the seat 10 illustrated in FIG. 1, wherein the illustration of FIG. 2 additionally shows a displacing element 26 and a shaft, which is coupled with a multi-disc brake 48. The shaft is in that case a part of the multi-disc brake 48. The displacing element 26 is arranged at the side wall 14 and coupled to the carry yoke 12. In further embodiments, the displacing element 26 can be coupled to the carry yoke 12 by way of the multi-disc brake 48. The opposite side wall 16 similarly comprises a displacing element 26, which is coupled to the carry yoke 12 and connected with the seat element 18. This displacing element 26 can be similarly coupled to the carry yoke 12 by way of a multi-disc brake 48. The displacing elements 26 have projections which are rotatably received in openings 44 of the seat element 18 (pivot axis B). If the carry yoke 12 is brought from the setting shown in FIG. 2 to a vertical setting then pivotation of the displacing elements 26 about the centre-of-gravity axis A in the direction of the seat back part 24 can take place, in which case the seat element 18 is pushed into the seat 10. For that purpose the multi-disc brakes 48 are so arranged and constructed that pivotation of the carry yoke 12 can be carried out and in addition braking of the pivotation of the displacing elements 26 is possible. At the same time, in the case of pivotation of the displacing elements 26 the spacing of the backrest element 20 from the seat back part 24 is reduced in the lower region 34.

FIG. 3 shows a section through the seat 10 of FIG. 1. FIG. 3 shows the illustration without displacing element 26 and without multi-disc brake 48. FIG. 3 shows, just as FIG. 1, the lying setting, in which the carry yoke 12 is arranged in a pivoted, substantially horizontal position. In addition, the backrest element 20 is disposed at a spacing from the seat back part 24. In particular, the spacing of the backrest element 20 in the connecting region 30 as well as between the connecting region 30 in the lower region 34 of the backrest element 20 and the upper end 28 of the backrest element 20 is greater than in the upper end 28 of the backrest element 20, in which the backrest element 20 is connected with the seat 10.

The function of the seat 10 in the event of an accident is described in the following, wherein the seat 10 is so arranged in a vehicle that the viewing direction of the child received therein is oriented towards the back of the vehicle.

The back of the child substantially rests on the backrest element 20. The posterior and the legs of the child rest on the seat element 18, the posterior being received in, in particular, the reinforced connecting region 30. In the event of an accident the child is in the first instance pressed against the backrest element 20. The backrest element 20 then seeks to move rearwardly in the direction of the seat back part 24. By way of a coupling of the backrest element 20 to the seat element 18 the seat element 18 seeks to displace. In that case, the displacing elements 26 seek to turn about the centre-of-gravity axis A in clockwise sense. Turning of the displacing elements 26 and thus displacement of the backrest element 20 and the seat element 18 take place, however, only if the torque, which is exerted by way of the energy liberated in the event of an accident, on the shaft connected with the displacing element 26 is of such a magnitude that the braking effect of the multi-disc brake 18 is not sufficient to fully absorb the liberated energy. If the liberated energy exceeds the absorption capability of the multi-disc brake 48 the backrest element 20 then pivots about the upper end 28 and partly deforms. In addition, due to the displacement of the backrest element 20 the seat element 18 is pushed along the seat lower part in the direction of the seat back part 24 and into the seat 10. The accident energy which arises is absorbed by the multi-disc brake 48, the deformation of the backrest element 20 and the displacement of the backrest element 20 as well as the seat element 18. After the energy liberated by the accident has been absorbed, the backrest element 20 can by virtue of its flexible design move back into the starting setting, which is shown in FIG. 3. In addition, the seat element 18 is similarly displaced forwardly again, in which case the multi-disc brake 48 can even assist such a return.

FIG. 4 shows a section through the seat 10 of FIG. 2. In FIG. 4 there is illustration of the displacing element 26, which is coupled to the carry yoke 12 and the multi-disc brake 48 and connected with the seat element 18. The illustration shown in FIG. 4 shows, just like the illustration shown in FIG. 3, the lying position of the seat 10. In a seating position the carry yoke 12 is brought upwardly in clockwise sense into a substantially vertical setting. In that regard, the displacing element 26 connected with the carry yoke 12 is pivoted downwardly. The pivotation of the displacing element 26 produces a displacement of the seat element 18. The seat element 18 is displaced in the seat 10 in the direction of the seat back part 24 along the seat lower part 22. Due to the displacement of the seat lower part 18, the backrest element 20 is similarly displaced. The backrest element 20 is additionally pivoted about a notional axis in the upper end 28, in which the case the spacing between the seat back part 24 and the backrest element 20 is reduced. Moreover, the backrest element 20 and the seat element 18 are so connected together that a part of the backrest element 20 is displaced along the seat element 18. In that regard, the support area of the seat 10, which is formed by the backrest element 20 and the seat element 18, is reduced.

FIG. 5 shows an alternative construction of a damping device for a seat 10. The damping device comprises tension springs 50, only one tension spring 50 being illustrated in FIG. 5. The tension spring 50 is connected at a first end 52 with a seat lower part 22 and at a second end 54 with the seat element 18. In order that the seat element 18 can be displaced, the energy acting for that purpose on the seat element 18 has to be of such a magnitude that the tension spring 50 is expanded. Depending on the tension spring 50 used, displacement of the seat element 18 and of the backrest element 20 takes place at different levels of energy. The seat 10 can therefore still also be used for a child when the child is older and thus heavier, in which case the severity of an accident at which a displacement takes place remains substantially the same.

FIG. 6 shows a further alternative construction of a damping device for a seat 10. The damping device comprises tension springs 50, only one tension spring 50 being illustrated in FIG. 6. The tension spring 50 is arranged at a first end 52 with a wall part of the seat 10 in the region, by way of which a carry yoke (not illustrated) is coupled to the seat 10. The tension spring 50 is connected at a second end 54 with the backrest element 20. In order that the backrest element 20 can be displaced, the energy acting for that purpose on the backrest element 20 has to be of such a magnitude that the tension spring 50 is expanded. Depending on the tension spring 50 used, displacement of the seat element 18 and the backrest element 20 can take place at different levels of energy. The seat 10 can therefore also still be used by a child when the child is older and thus heavier, in which case the severity of an accident at which a displacement takes place remains substantially the same.

In further embodiments (not illustrated) use can be made not only of tension springs 50, as illustrated in FIG. 5, but also tension springs 50, as illustrated in FIG. 6. In addition, a combination of a multi-disc brake 48 with at least one tension spring 50 (FIG. 5 and/or FIG. 6) is provided in further embodiments.

### REFERENCE NUMERAL LIST

10 seat

12 carry yoke

14 side wall

16 side wall

18 seat element

20 backrest element

22 seat lower part

24 seat back part

26 displacing element

28 upper end

30 connecting region

32 opening

34 lower region

36 leg support region

38 locking device

40 opening

42 guide gate

44 opening

46 suspension means

48 multi-disc brake

50 tension spring

52 end

54 end

A centre-of-gravity axis

B pivot axis

1. A seat for infants and toddlers, comprising at least a seat lower part and a seat back part, wherein a seat element at the seat lower part and a backrest element at the seat back part are mounted to be displaceable and connected together, wherein
at least the backrest element is of flexible construction and arranged at a spacing from the seat back part,
the backrest element is so arranged and constructed that the backrest element is displaceable under the action of impulse energy by the body of the child,
at least one of the backrest element and the seat element is connected with at least one damping device and
the at least one damping device allows displacement of the backrest element from a definable level of impulse energy, whereby the spacing between the backrest element and the seat back part is reduced and displacement of the seat element relative to the seat lower part takes place.

2. The seat according to claim 1, wherein the backrest element when in a lying position is arranged at a spacing from the seat back part and the backrest element can be brought by way of a mechanism from a seating position, in which the backrest element has a small spacing from the seat back part, into the lying position.

3. The seat according to claim 2, wherein the seat lower part and the seat back part are components of a bucket seat of a baby carrier to which a carry yoke is pivotably attached at least at one end and the backrest element is coupled to the carry yoke of the seat, wherein the backrest element can be brought from the seating position to the lying position by way of displacement of the carry yoke from a first position to a second position.

4. The seat according to claim 3, wherein the seat element is coupled to at least one displacing element and is connected with the carry yoke and the connection of the seat element with the backrest element produces transfer of the backrest element from the seating position to the lying position.

5. The seat according to claim 3, wherein the carry yoke is pivotably mounted substantially at the centre-of-gravity axis (A) of the seat and is lockable at least in the vertical carrying setting.

6. The seat according to claim 1, wherein the at least one damping device is coupled to the backrest element and the seat element in the region of a connection axis of the backrest element and the seat element.

7. The seat according to claim 1, wherein the at least one damping device comprises at least one of hydraulic braking means, magnetic braking means and mechanical braking means.

8. The seat according to claim 1, wherein the damping device comprises at least one spring which counteracts displacement of the backrest element and the seat element, wherein the at least one spring is coupled to or connected with at least one of the backrest element, the seat element and the displacing element.

9. The seat according to claim 14, wherein the at least one damping device comprises a multi-disc brake coupled to or connected with the at least one of the backrest element, the seat element and the displacing element.
